(19) United States
(12) Patent Application Publication
(10) Pub. No.: US 2018/0107906 A1
(43) Pub. Date: Apr. 19, 2018

(54) IMAGE FORMING APPARATUS AND INFORMATION PROCESSING METHOD

(71) Applicant: FUJI XEROX CO., LTD., Tokyo (JP)

(72) Inventors: Junichi SHIMIZU, Yokohama-shi (JP); Hiroshi HAYASHI, Yokohama-shi (JP); Kiyotaka TSUCHIBUCHI, Yokohama-shi (JP); Hiroshi NIINA, Yokohama-shi (JP); Masashi OKANO, Yokohama-shi (JP); Tetsuya WAKIYAMA, Yokohama-shi (JP)

(73) Assignee: FUJI XEROX CO., LTD., Tokyo (JP)

(21) Appl. No.: 15/483,422

(22) Filed: Apr. 10, 2017

(30) Foreign Application Priority Data
Oct. 14, 2016 (JP) 2016-202854

(51) Int. Cl. G06K 15/02; H04N 1/00; G06K 15/14; H04N 1/56; G03G 15/00

(52) U.S. Cl. CPC G06K 15/1857; H04N 1/00798; H04N 2201/0081; H04N 1/56; G03G 15/50; G06K 15/14

(57) ABSTRACT

An image forming apparatus includes: a first information processing unit that performs information processing for image formation on obtained image data by an image processing specific program; and a second information processing unit that performs information processing for image formation on the image data by a general-purpose processing program also performing processing other than image processing when a value related to the information processing by the first information processing unit satisfies a predetermined condition.

### CROSS REFERENCE TO RELATED APPLICATIONS

This application is based on and claims priority under 35 USC § 119 from Japanese Patent Application No. 2016-202854 filed Oct. 14, 2016.

### BACKGROUND

### Technical Field

The present invention relates to an image forming apparatus and an information processing method.

### Related Art

In recent years, apparatuses having a CPU with multiple cores (processors) have been widely used.

### SUMMARY

According to an aspect of the present invention, there is provided an image forming apparatus including: a first information processing unit that performs information processing for image formation on obtained image data by an image processing specific program; and a second information processing unit that performs information processing for image formation on the image data by a general-purpose processing program also performing processing other than image processing when a value related to the information processing by the first information processing unit satisfies a predetermined condition.

### BRIEF DESCRIPTION OF THE DRAWINGS

An exemplary embodiment of the present invention will be described in detail based on the following figures, wherein:

FIG. 1 is a block diagram illustrating a configuration of an image forming apparatus to which an exemplary embodiment is applied;

FIG. 2 is a diagram showing an output device when being viewed from a front side;

FIGS. 3A and 3B are block diagrams illustrating how to specify tasks to cores in a CPU: FIG. 3A shows a normal case; and FIG. 3B shows a case other than the normal case;

FIG. 4 is a block diagram illustrating image processing in an FCOT reduction mode;

FIG. 5 is a time chart illustrating processing in the FCOT reduction mode;

FIG. 6 is a time chart illustrating processing in the FCOT reduction mode;

FIGS. 7A and 7B are diagrams illustrating cases in which the number of cores for performing image processing is increased: FIG. 7A shows a case in 2-core operation; and FIG. 7B shows a case in 4-core operation;

FIG. 8A is a flowchart illustrating processing procedures of core number control in the CPU;

FIGS. 8B to 8D are block diagrams illustrating how to specify tasks to cores in a CPU;

FIG. 9A is a flowchart illustrating other processing procedures of the core number control in the CPU; and

FIGS. 9B to 9E are block diagrams illustrating how to specify tasks to cores in a CPU.

### DETAILED DESCRIPTION

Hereinafter, an exemplary embodiment according to the present invention will be described in detail with reference to attached drawings.

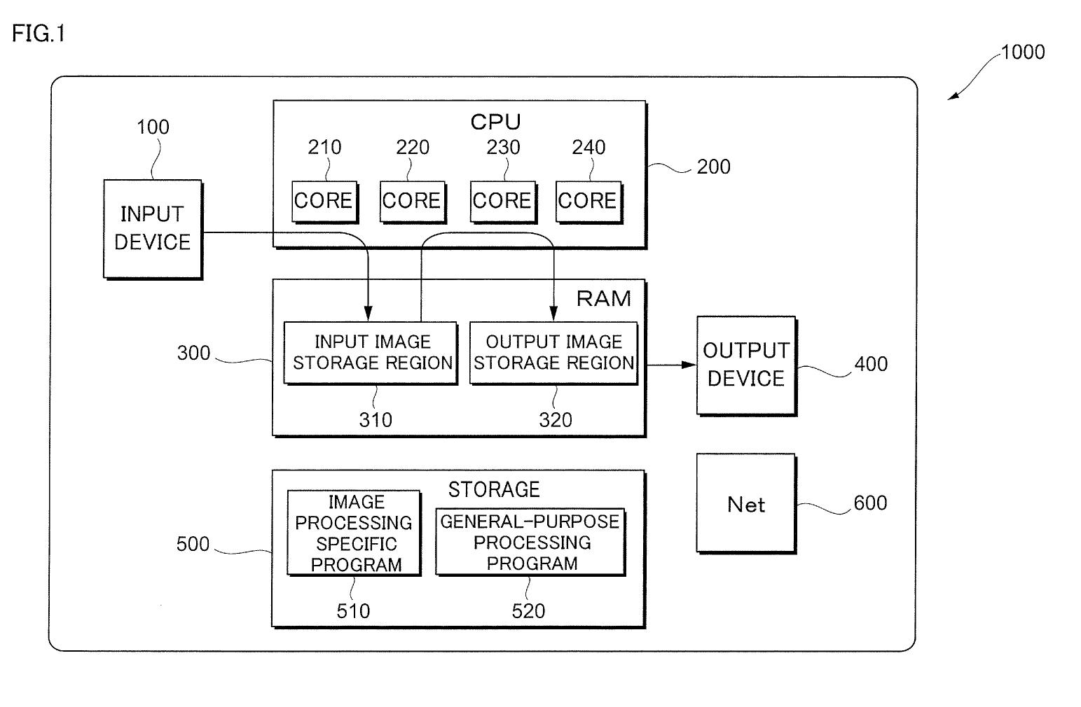

FIG. 1 is a block diagram illustrating a configuration of an image forming apparatus 1000 to which an exemplary embodiment is applied.

As shown in the figure, the image forming apparatus 1000 related to the exemplary embodiment includes an input device 100 to which image data or others are inputted from an image reading device (scanner), a personal computer (PC), and so forth. It can be thought that the input device 100 is configured to include the image reading device or the personal computer. A specific example can also be considered in which the input device 100 is, for example, a facsimile (FAX) device that transmits and receives image information via a public telephone line. Note that the image reading device is an example of an image reading unit.

Moreover, the image forming apparatus 1000 shown in FIG. 1 includes a CPU (Central Processing Unit) 200 that performs control of operations of each device (each section) and a RAM (Random Access Memory) 300 used as a work area of the CPU 200. In addition, the image forming apparatus 1000 includes: an output device 400 that outputs an image subjected to image processing by the CPU 200 onto a medium; a storage 500 that is an external memory configured with, for example, a hard disk drive (HDD), a flash memory, or the like, to store information, such as programs in the CPU 200, and to temporarily accumulate image data or others inputted by the input device 100; and a Net 600 that communicates with the outside.

Note that the image forming apparatus 1000 is able to include a not-shown user interface (UI) device that accepts an operation input from a user or displays various kinds of information items to a user.

The CPU 200 shown in FIG. 1 will be further described.

The CPU 200 of the image forming apparatus 1000 performs not only image processing on image data inputted through the input device 100, but also, for example, control processing of the input device 100 and the Net 600. Moreover, when a facsimile device is included, the CPU 200 performs control processing of transmission and reception by the facsimile device, and when a UI device is included, the CPU 200 performs display processing or operation acceptance processing of the UI device.

In this manner, the CPU 200 performs various types of image processing, and other than performing control of operations of each device (each section), performs image processing.

Note that, with respect to a function of performing image processing, an example, in which the function is implemented by an ASIC (Application Specific IC, an integrated circuit for a specific purpose) can be thought; however, in the exemplary embodiment, the CPU 200 reads programs from the storage 500, to thereby implement the image processing function. In other words, in the exemplary embodiment, the image processing is performed by software processing by use of the CPU.

To describe further, the storage 500 stores programs to be executed by the CPU 200.

The CPU 200 reads the programs stored in the storage 500 and executes the programs by using the RAM 300 as a work area.

The programs stored in the storage 500 are executed by the CPU 200, and thereby each functional section to be described later is implemented.

Note that the storage 500 stores at least an image processing specific program 510 and a general-purpose processing program 520. Then, the CPU 200 operates cores 210 and 220 in the CPU 200 by the image processing specific program 510, and operates cores 230 and 240 in the CPU 200 by the general-purpose processing program 520.

Here, the programs executed by the CPU 200 can be provided to the image forming apparatus 1000 in a state of being stored in a recording medium readable by a computer, such as a magnetic recording medium (a magnetic tape, a magnetic disk or the like), an optical recording medium (an optical disk or the like), a magneto-optical recording medium or a semiconductor memory. Moreover, the programs executed by the CPU 200 may be downloaded to the image forming apparatus 1000 by use of a communication tool, such as the Internet.

Note that the image forming apparatus 1000 shown in FIG. 1 is an example of an image forming apparatus; however, for example, a configuration in FIG. 1 without the output device 400 or a configuration in FIG. 1 without the input device 100 and the output device 400 can be grasped as an example of an information processing apparatus.

The output device 400 is an example of an output unit.

Next, the output device 400 of the image forming apparatus 1000 will be described.

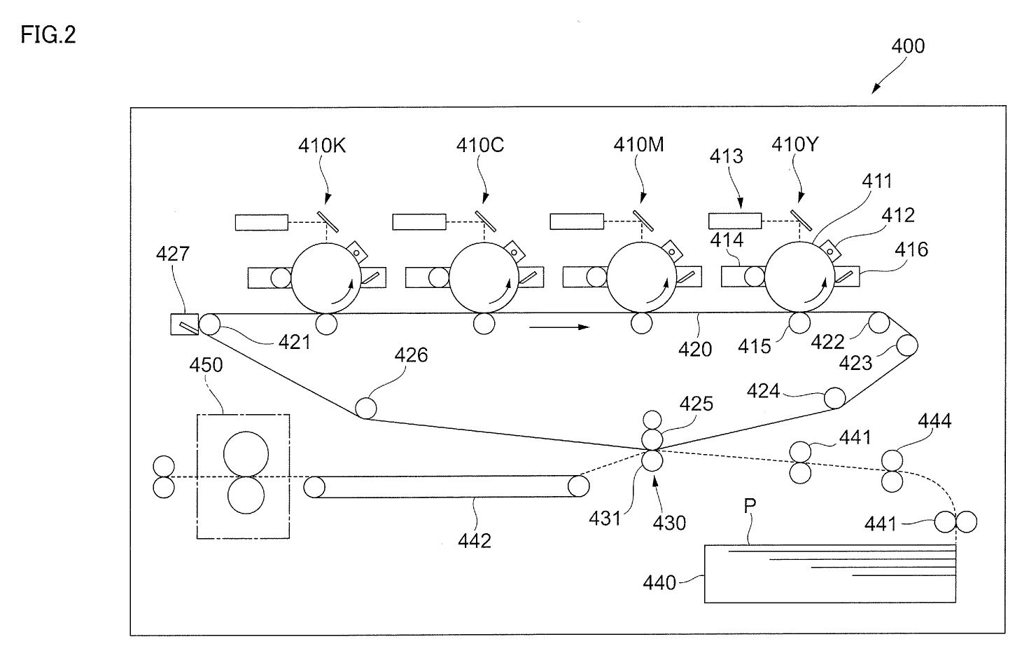

FIG. 2 is a diagram showing the output device 400 when being viewed from a front side.

The output device 400 shown in the figure has a configuration of a so-called tandem type and includes plural image forming units 410Y, 410M, 410C and 410K (in this specification, collectively referred to as an image forming units 410 in some cases) for forming toner images of respective color components by the electrophotographic system.

Moreover, the output device 400 includes an intermediate transfer belt 420, as an example of an image forming unit, to which the toner images of the respective color components formed in the respective image forming units 410 are sequentially transferred (primary transfer) and which holds the toner images of the respective color components, and a secondary transfer device 430, as an example of a transfer unit, that collectively transfers the toner images of the respective color components on the intermediate transfer belt 420 onto a recording material P formed in a rectangular shape (secondary transfer). The recording material P is a medium on which fixing is performed, such as paper, film, or the like.

Moreover, the output device 400 is provided with a sheet feeder 440 that feeds the recording material P. Moreover, between the sheet feeder 440 and the secondary transfer device 430, plural transport rolls 441 for transporting the recording material P positioned on a sheet transport route are provided.

Moreover, in the exemplary embodiment, a fixing device 450, as an example of a fixing unit that fixes the image having been secondarily transferred onto the recording material P by the secondary transfer device 430 onto the recording material P is provided. Further, between the secondary transfer device 430 and the fixing device 450, a transport device 442 that transports the recording material P having passed through the secondary transfer device 430 to the fixing device 450 is provided.

Here, each of the image forming units 410 functioning as part of an image forming section includes a photoconductive drum 411 that is rotatably attached. Moreover, around the photoconductive drum 411, there are provided a charging device 412 that charges the photoconductive drum 411, an exposure device 413 that exposes the photoconductive drum 411 to write an electrostatic latent image, and a developing device 414 that visualizes the electrostatic latent image on the photoconductive drum 411 with toner. Further, there are provided a primary transfer device 415 that transfers the toner images of the respective color components formed on the photoconductive drum 411 onto the intermediate transfer belt 420, and a drum cleaner 416 that removes residual toner on the photoconductive drum 411.

The intermediate transfer belt 420 is provided to be disposed on plural roll members 421, 422, 423, 424, 425 and 426 to be rotated. Of these roll members 421 to 426, the roll member 421 is configured to drive the intermediate transfer belt 420. Moreover, the roll member 425 is provided to face a secondary transfer roll 431 with the intermediate transfer belt 420 being interposed therebetween; accordingly, the secondary transfer device 430 is configured with these secondary transfer roll 431 and roll member 425.

Note that, at a position facing the roll member 421 with the intermediate transfer belt 420 being interposed therebetween, a belt cleaner 427 that removes residual toner on the intermediate transfer belt 420 is provided.

Here, upon returning to FIG. 1, the CPU 200 will be further described.

As shown in FIG. 1, the CPU 200 includes the core 210, the core 220, the core 230 and the core 240. In other words, the CPU 200 related to the exemplary embodiment includes plural processor cores (cores), and realizes high processing speed by use of a multitasking operating system. Note that, in the exemplary embodiment, a configuration with four cores is adopted; however, other examples of a configuration with cores of a different number can be considered as long as the configuration includes plural cores.

When control is performed by such multi-core CPU and multitasking operating system, generally, there are two methods: control that assigns tasks to be processed to all of the cores (SMP (Symmetrical multi-processing)); and control that specifies a specific core for each task to be processed (AMP (Asymmetrical multi-processing)), and in the exemplary embodiment, the latter one, namely, AMP is adopted.

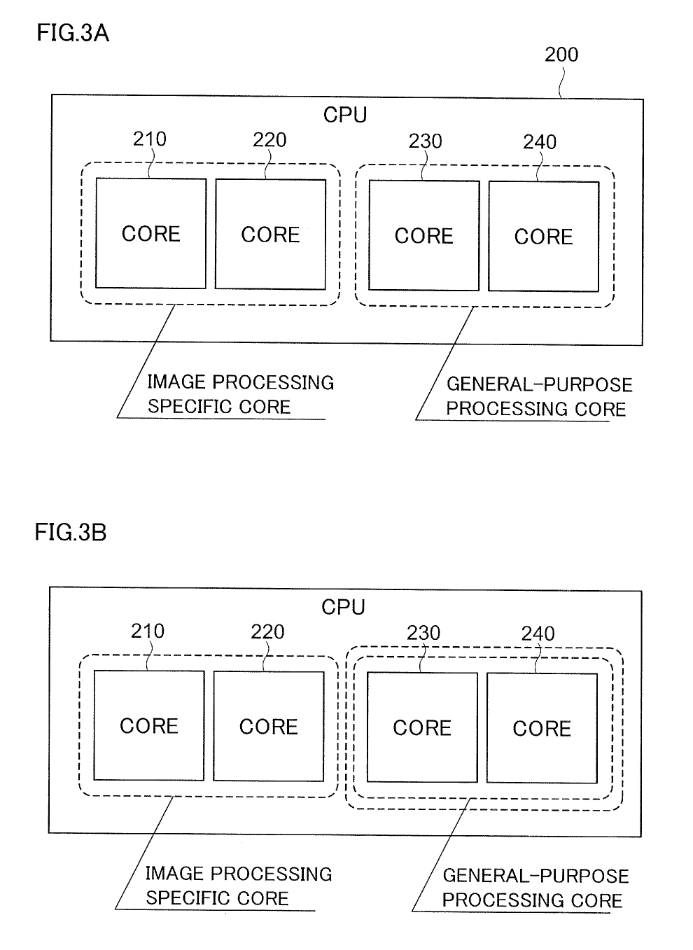

In other words, the image forming apparatus 1000 has a large number of tasks to be processed, and moreover, the image forming apparatus 1000 is an appliance performing combination of processing, such as a print function, a scanning function, a facsimile function, UI processing, network processing, and so forth. Therefore, for the sake of efficiency in image processing, the configuration of AMP that uses part of the four cores 210 to 240 for image processing and the other cores for processing other than image processing is adopted. In the present specification, the core used for image processing is referred to as “image processing specific core”, and the core used for processing other than image processing is referred to as “general-purpose processing core” in some cases. Note that, as will be described later, the general-purpose processing core occasionally performs image processing. With FIGS. 3A and 3B, a description in more detail will be provided.

These figures are block diagrams illustrating how to specify tasks to the cores 210 to 240 in the CPU 200: FIG. 3A shows a normal case; and FIG. 3B shows a case other than the normal case (a case in which a delay occurs in image processing).

In the normal case, as shown in FIG. 3A, of the four cores 210 to 240 in the CPU 200, the cores 210 and 220 are specified as the image processing specific cores, and the other cores 230 and 240 are specified as the general-purpose processing cores. Accordingly, image processing in the normal case is performed by use of the cores 210 and 220, and processing other than the image processing is performed by use of the cores 230 and 240.

Such cores 210 and 220 are operated by the image processing specific program 510 in the storage 500, and accordingly, specified as the image processing specific cores. Moreover, the cores 230 and 240 are operated by the general-purpose processing program 520 in the storage 500, and accordingly, specified as the general-purpose processing cores.

The cores 210 and 220 in the CPU 200 are an example of a first information processing unit, and the cores 230 and 240 are an example of a second information processing unit. The image processing specific program 510 in the storage 500 is an example of an image processing specific program, and the general-purpose processing program 520 is an example of a general-purpose processing program.

In the case other than the normal case shown in FIG. 3B, there is no change in specifying the cores 210 and 220 as the image processing specific cores; however, the cores 230 and 240 are specified as general-purpose processing cores also performing image processing. In other words, the cores 230 and 240 performs image processing in addition to performing processing other than the image processing. In more detail, when the processing speed is slowed down (or, when the processing time becomes longer) in performing image processing by the image processing specific cores (the cores 210 and 220), control is performed to cause the general-purpose processing cores (the cores 230 and 240) to also perform image processing.

In the cores 230 and 240, when image processing is not performed, priority of each processing of control of an input/output appliance, facsimile control, UI processing, network processing and others may be the same, or the priority may be determined for each processing; however, when the image processing is performed, the priority of the image processing is increased to perform thereof.

Technical background to control such image processing will be described.

In the image forming apparatus 1000, a time from pressing a start button (not shown) as an instructing operation to copy a document set on an image reading device (not shown) as the input device 100 to outputting a sheet on which an image of a read image is formed (FCOT (First Copy Output Time)) is regarded as one of evaluation criteria, and it is desirable that such a time is reduced. Consequently, in the image forming apparatus 1000 related to the exemplary embodiment, for example, when a copy instruction is provided with specific setting, such as, the document size of A4 and a certain color mode, control is performed to operate in a mode for reducing the FCOT (FCOT reduction mode).

Such an FCOT reduction mode is an operation mode for directly outputting read image data to the output device 400 without being accumulated in the storage 500 (refer to FIG. 1), in which a time from pressing the start button (not shown) to delivering the image data to the output device 400 (refer to FIG. 1) including an image processing time is calculated in advance, and based on the calculated time, a timing when the output device 400 starts operation after the start button (not shown) is pressed is set. In other words, the output device 400 starts operation without waiting for completion of image processing for one page of the read image.

However, when the image processing is performed by the CPU 200 as in the exemplary embodiment, not by the above-described ASIC, variability in the processing time occurs depending on image data. When such variability is a delay in image processing, a situation in which not all the image is formed on the sheet is assumed. To deal with such a situation, for example, a high-performance CPU 200 is employed, however, it becomes difficult to realize cost cuts. Moreover, when an operation start time of the output device 400 is delayed, the FCOT becomes long, which is not preferred.

Therefore, in the exemplary embodiment, control to change the use of the cores 230 and 240 between the normal case and the case where the delay in image processing occurs is performed, to thereby suppress occurrence of situation in which not all the image is formed on the sheet. Note that, in a technique that performs distribution processing by automatically assigning cores to each application processing so that all of the cores 210 to 240 are used, assignment to multiple cores in response to processing contents of applications is not carried out, and accordingly, it is difficult to perform efficient assignment of the multiple cores.

Hereinafter, the case of FCOT reduction mode will be concretely described.

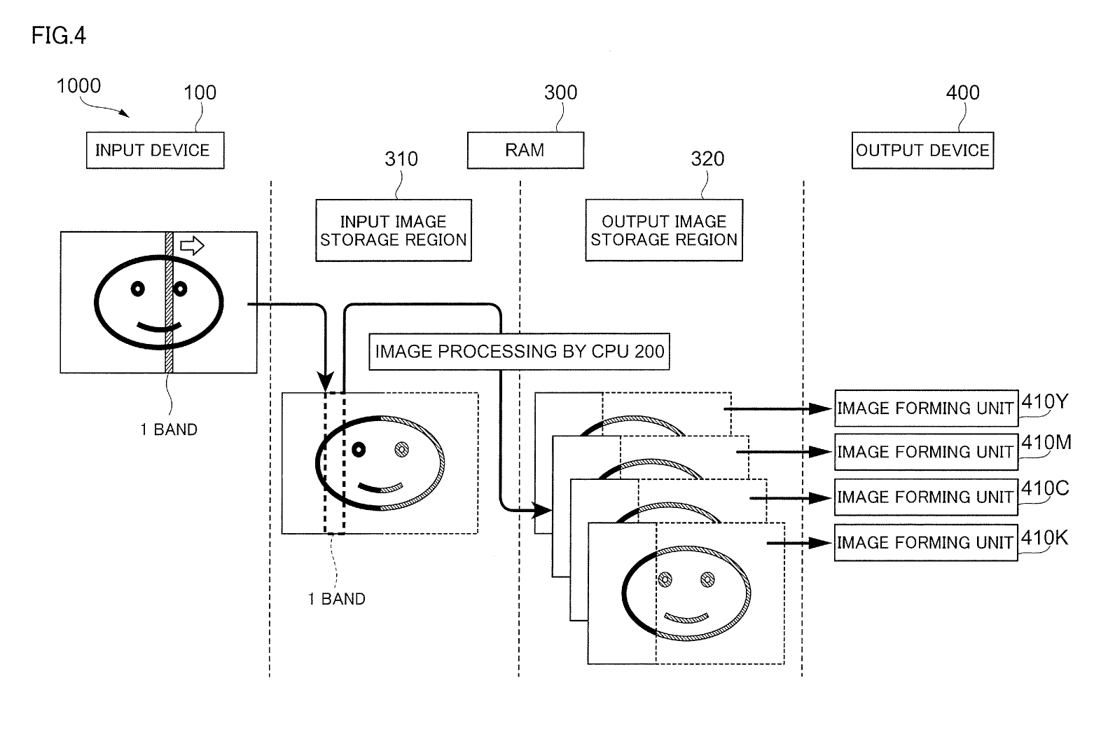

FIG. 4 is a block diagram illustrating image processing in the FCOT reduction mode.

As shown in the figure, in the image reading device as the input device 100, a document is sequentially read by each one band (the document is scanned from the left side to the right side in the figure), and scan data read in such a manner is stored in the input image storage region 310 of the RAM 300 by the CPU 200. Note that, as shown in FIG. 4, in the input image storage region 310, image data corresponding to a scanned region in the document is stored.

Storage into the input image storage region 310 in the RAM 300 like this is performed by the cores 210 and 220 (image processing specific cores) in the CPU 200; however, specific examples in which the storage is performed by the cores 230 and 240 (general-purpose processing cores) can also be considered.

Then, the cores 210 and 220 in the CPU 200 perform image processing of the scan data stored in the input image storage region 310 for image data of one band in order of being scanned. In other words, the cores 210 and 220 wait for the scan data of one band to be stored in the input image storage region 310, and, when the scan data of one band is stored, perform image processing of the scan data of one band indicated by a broken-line part in the input image storage region 310 in FIG. 4 in cooperation with each other or on a sharing basis.

The cores 210 and 220 store image data (output data) of each of Y, M, C and K colors generated by being subjected to image processing in each band in an output image storage region 320. Then, the cores 210 and 220 transmit the image data (output data) of each color having been stored to the output device 400 in conformity to operation of the output device 400.

Next, various types of processing in the case of FCOT reduction mode will be described along the time axis.

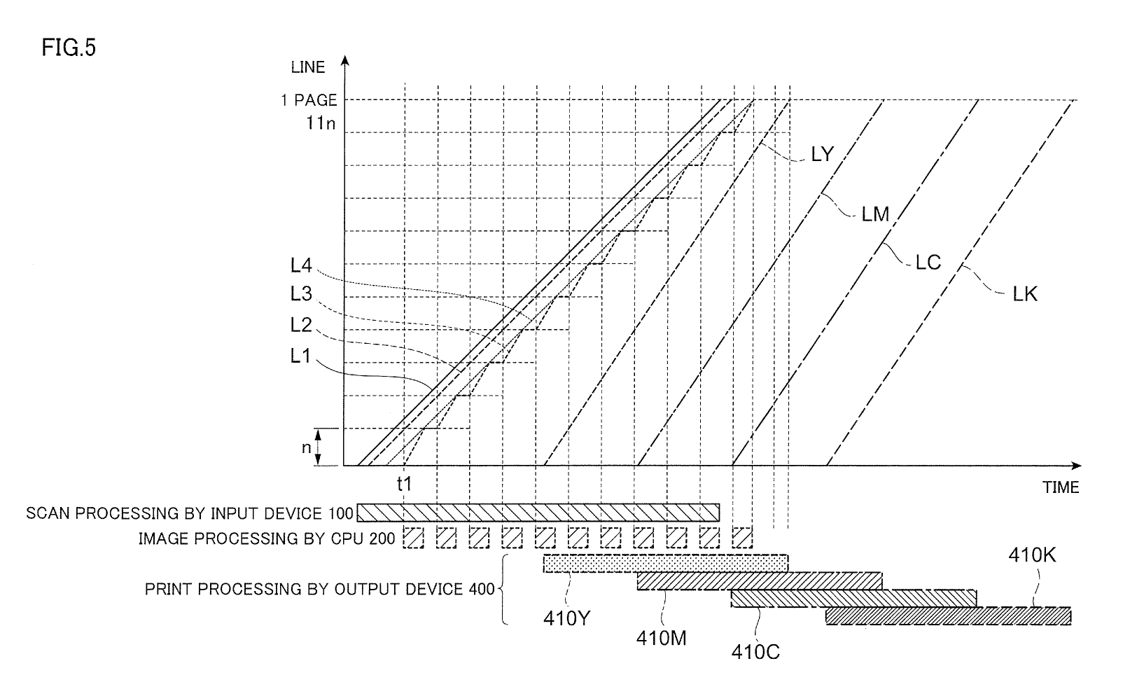

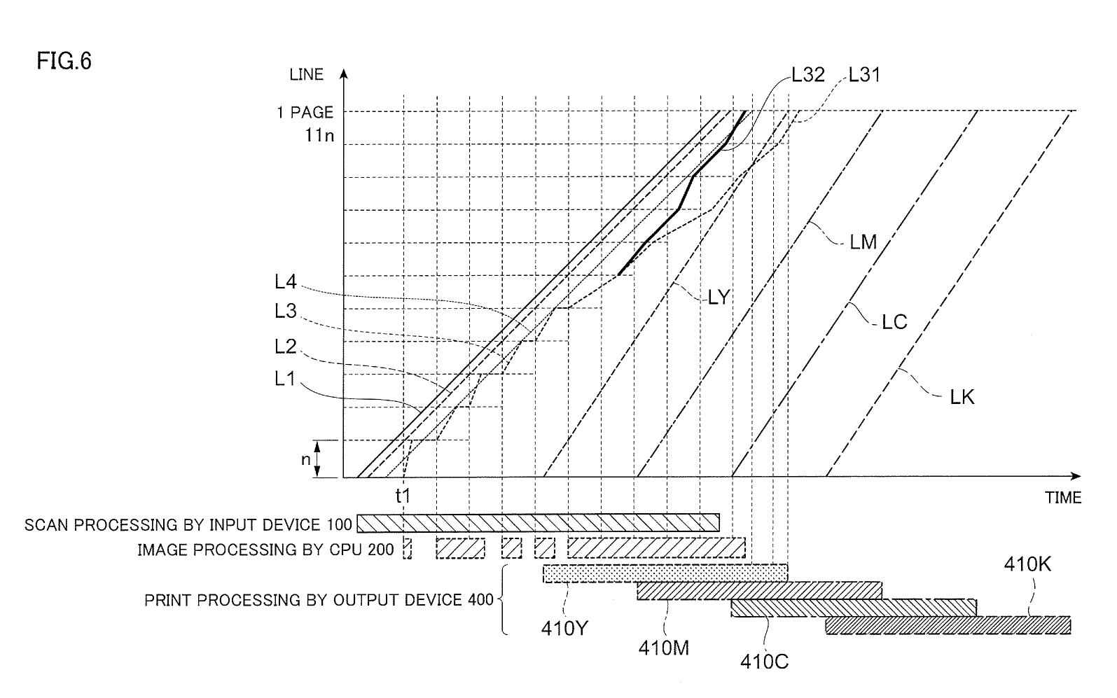

FIGS. 5 and 6 are time charts illustrating image processing in the FCOT reduction mode. FIG. 5 shows a first case in which there is a little variability in the processing time, and FIG. 6 shows a second case in which there is a lot of variability in the processing time. Note that the vertical axis in each figure indicates a line by the unit of a band n when being scanned, and the horizontal axis indicates the elapsed time. Each figure shows a case in which a document of one page is to be copied.

First, the time chart shown in FIG. 5 will be described. When the scan processing to read the document by the input device 100 (for example, refer to FIG. 1) is started (refer to line L1 indicated by the bold solid line), memory storage to store the scan data in the RAM 300 (for example, refer to FIG. 1) is started (refer to line L2 indicated by the broken line), and further, image processing by the CPU 200 (for example, refer to FIG. 1) is performed (refer to polygonal line L3 indicated by the broken line). The image processing by the CPU 200 is started at the point in time t 1 when memory storage of the scan data of one band is performed.

The image processing by the CPU 200 is shown as polygonal line L3, not a straight line. This is because variability occurs in the processing time depending on the contents of the scan data to be subjected to image processing, and, moreover, horizontal parts in polygonal line L3 indicate a state of not having been subjected to image processing and waiting for the scan data of one band to be subjected to memory storage. The state is apparent from rectangular portions showing the state of image processing by the CPU 200 indicated below the horizontal line. Note that, in the case of software of the CPU 200 that performs image processing by a program, such a waiting state possibly occurs; however, in the case of hardware of ASIC (not shown), since the operations conform to the processing speed or the processing time, there is no such a waiting state in image processing, and further, there are no fluctuations in the image processing time.

As shown in FIG. 5, an average processing time of image processing by the CPU 200 (refer to FIG. 1) is indicated by line L4 of a thin dotted line.

Then, as shown in FIG. 5, before the output data of one page is stored in the output image storage region 320 (refer to FIG. 1) in the RAM 300, an image forming operation (print processing) by the output device 400 is started by the so-called snap decision. In other words, first, the image forming unit 410Y of Y color positioned at the most upstream side (also refer to FIG. 2) starts to operate (refer to line LY indicated by a short-dashed line), and, next, the image forming unit 410M of M color operates (refer to line LM indicated by a short-dot-and-dash line). Thereafter, the image forming unit 410C of C color operates (refer to line LC indicated by a long-dot-and-dash line), and finally, the image forming unit 410K of K color operates (refer to line LK indicated by a long-dashed line).

Here, with reference to FIG. 5, the polygonal line L3 does not intersect the line LY, and in terms of the time axis (horizontal axis), the polygonal line L3 always precedes the line LY. This means that the image processing by the CPU 200 is performed before print processing in the image forming unit 410Y of Y color, which first starts image forming operation among the four image forming units 410Y, 410M, 410C and 410K, is performed.

To put it another way, a distance in the horizontal axis direction between the polygonal line L3 and the line LY shown in FIG. 5 corresponds to a time difference from generation of output data by the CPU 200 to Y-color printing by the output device 400 for one band in the input device 100. Consequently, existence of such a time difference means that, when the output device 400 intends to print, the output data is obtained from the RAM 300; accordingly, a so-called incomplete image, due to that obtaining of the output data misses the print timing, does not occur. To describe further, the time difference described above can be regarded as a temporal margin not to cause the incomplete image.

Therefore, in the case shown in FIG. 5, the image processing in the CPU 200 is performed by the cores 210 and 220 in the CPU 200, and is not performed by the cores 230 and 240 (refer to FIG. 3A). In other words, since image processing only by the two cores 210 and 220, which are the image processing specific cores, does not cause the incomplete image, it is unnecessary to execute control that performs image processing by the cores 230 and 240, which are the general-purpose processing cores.

Next, by using FIG. 6, a case in which the image processing is performed not only by the cores 210 and 220 (for example, refer to FIG. 1), but also by the cores 230 and 240 (for example, refer to FIG. 1) will be described. As described above, similar to FIG. 5, the vertical axis in FIG. 6 indicates lines, and similar to FIG. 5, the horizontal axis in FIG. 6 indicates the elapsed time. Note that, when FIG. 6 is described, description of parts thereof overlapping those in FIG. 5 is omitted in some cases.

In the graph shown in FIG. 6, by observing relative positional relationship between the polygonal line L3 indicating the status of image processing by the CPU 200 and the line L4 indicating the average processing time, portions where the polygonal line L3 is positioned on the left side of the line L4 are found. Specifically, the portions exist in the cases of the line n and the line 3n in FIG. 6.

In such cases, it is indicated that the image processing by the cores 210 and 220 in the CPU 200 is completed more quickly than the average processing time.

Moreover, in the graph shown in FIG. 6, there is a portion where the polygonal line L3 is positioned on the right side to be widely separated from the line L4. Specifically, the portion exists in the case of the line 6n in FIG. 6.

In such a case, it is indicated that the image processing by the cores 210 and 220 in the CPU 200 is completed behind the average processing time. In other words, in this stage, a delay occurs in the image processing by the cores 210 and 220 (in 2-core operation), and, as indicated by polygonal line L31 continued from the polygonal line L3 in FIG. 6, the image processing is too late for print processing by the output device 400; accordingly, a possibility of occurrence of incomplete image (refer to intersection of the polygonal line L31 and the line LY) is increased.

Then, as polygonal line L32 indicated by the bold solid line in FIG. 6, the CPU 200 performs control to increase the number of cores to be used in image processing. As a specific example of conditions to perform such a control to increase the number of cores, a case in which a cumulative processing time from the start of processing is compared with a cumulative average processing time when the image processing of one band is completed, and if there is a delay in processing, the number of cores to be used in image processing is increased can be provided.

To describe further, the CPU 200 performs image processing in the next line, that is, in the line 7n not only by the cores 210 and 220, but also by the cores 230 and 240 (in 4-core operation). In other words, the cores 230 and 240 are specified as the cores that temporarily perform image processing (refer to FIG. 3B). In more detail, the cores 230 and 240 perform the image processing prior to other processing.

A shift from the 2-core operation to the 4-core operation is carried out at the timing of starting the image processing for the next one band.

Note that, when the number of cores assigned to the image processing is increased in the CPU 200, as the core number control after the increase, a control to reduce the number of cores is not performed during page processing. When the delay in image processing is recovered, other than such a control, it can be considered that a control to reduce the number of cores to the original number is performed. Such a control to reduce the number of cores is executed at the timing of starting the image processing for the next one band, and in addition, also executed while the image processing for one band is performed.

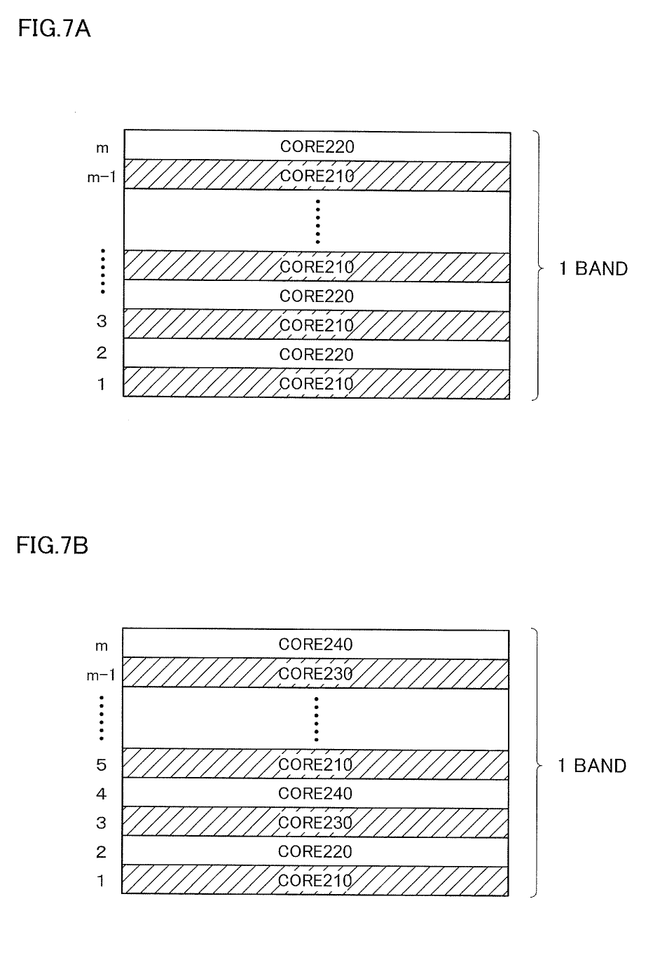

FIGS. 7A and 7B are diagrams illustrating cases in which the number of cores that perform image processing are increased: FIG. 7A shows a case in the 2-core operation in which the image processing is performed by the cores 210 and 220; and FIG. 7B shows a case in the 4-core operation in which the image processing is performed by the cores 210 to 240.

In the 2-core operation, the cores 210 and 220 partially deal with the scan data of one band alternately, to thereby perform the image processing. In other words, as shown in FIG. 7A, when the scan data is divided into m in the order of being scanned, the image processing for the first (odd number) line is dealt with by the core 210, and the image processing for the second (even number) line is dealt with by the core 220. After this, similarly, the cores 210 and 220 alternately deal with the image processing in order.

Moreover, in the 4-core operation, the cores 210 to 240 partially deal with the scan data of one band in order, to thereby perform the image processing. In other words, as shown in FIG. 7B, of the scan data divided into m, the image processing for the first line is dealt with by the core 210, the image processing for the second line is dealt with by the core 220, the image processing for the third line is dealt with by the core 230 and the image processing for the fourth line is dealt with by the core 240. Then, such as the image processing for the fifth line is dealt with by the core 210, the cores 210 to 240 perform the image processing in order.

Therefore, in the 4-core operation, the cores 230 and 240 perform the image processing at the highest priority, and therefore, processing other than the image processing is delayed.

Next, processing procedures of the core number control in the CPU 200 will be described.

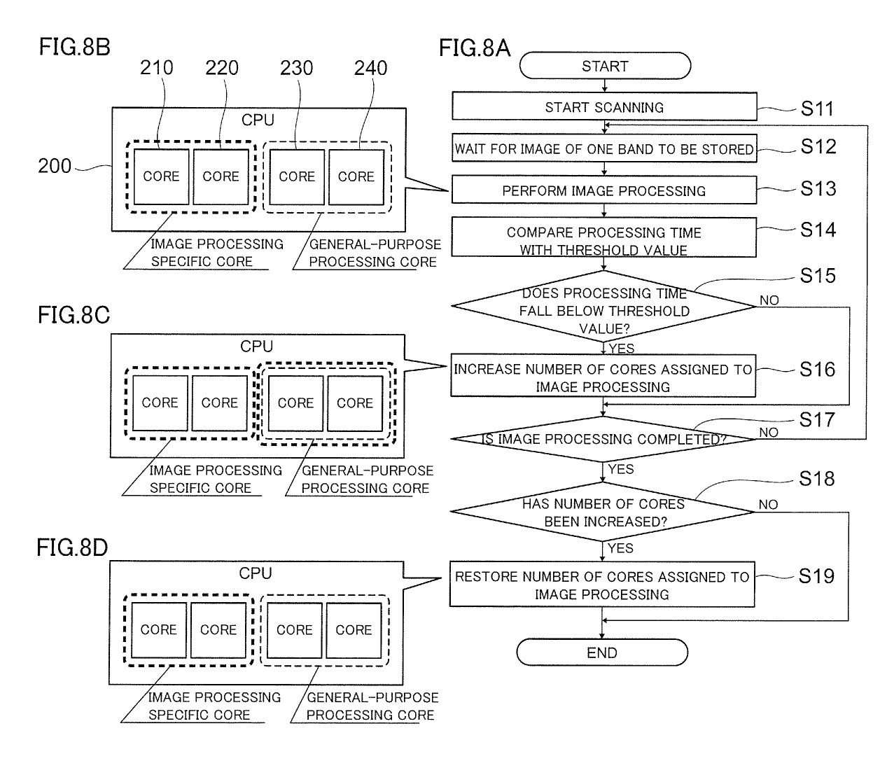

FIG. 8A is a flowchart illustrating the processing procedures of the core number control in the CPU 200, and FIGS. 8B to 8D are block diagrams illustrating how to specify tasks to cores in the CPU 200. Note that, in FIGS. 8A to 8D, the cores 210 to 240 are enclosed by the broken lines: the broken lines enclosing the cores performing image processing are indicated by bold lines; and the broken lines enclosing the cores performing processing other than the image processing are indicated by thin lines.

In the processing procedures shown in FIGS. 8A to 8D, when scanning of a document is started in the input device 100 (S11), the CPU 200 obtains an image of the document by one band, and performs image processing of the obtained document image by one band. In more detail, the CPU 200 waits for the image of one band of the document image to be stored in the input image storage region 310 (refer to FIG. 1) in the RAM 300 (S12), and thereafter, performs image processing by the cores 210 and 220 that are the image processing specific cores (S13).

In this manner, the CPU 200 starts image processing at the timing of obtaining the image of one band. The image processing in this stage is performed only by the cores 210 and 220 (also refer to FIG. 7B), the cores 230 and 240, which are the general-purpose processing cores, do not perform the image processing, but perform processing other than the image processing. Consequently, when obtaining of image data of one band is completed, the cores 210 and 220 start image processing of the image data. In other words, the cores 210 and 220 of the CPU 200 perform the image processing at the obtaining timing.

To additionally describe, it is the cores 210 and 220, which are the image processing specific cores, that perform the image processing of the image data of one band having been first obtained, and moreover, the image processing of the image data of one band that is obtained thereafter is performed only by the cores 210 and 220 (in the 2-core operation) in some cases, or by the cores 210 to 240 (in the 4-core operation) in some other cases.

During the image processing is performed, the processing time is measured, and the processing time is compared with a threshold value (S14). In other words, it is determined whether or not the processing time falls below the threshold value. The above-described threshold value is calculated based on, for example, the scanning speed (reading speed) of the input device 100, the processing speed of the output device 400, the processing performance of the CPU 200 (the cores 210 to 240), or the type of the image processing (for example, color outputting or monochrome outputting). Note that a configuration example in which the threshold value is held as a table in advance can be considered.

Here, the processing time as a target for comparison can be the processing time when the image processing is performed on image data of one band. Moreover, in the exemplary embodiment, the target for comparison with the threshold value is the processing time; however, the target is not limited thereto, and it can be considered that, for example, the target is a value, such as the image processing speed.

The above-described value, such as the processing time or image processing speed, is an example of a value related to image formation. Moreover, criterion for determination of whether or not the processing time falls below the threshold value is an example of a predetermined condition.

When the measured processing time falls below the threshold value (Yes in S15), the CPU 200 increases the number of cores to be assigned to the image processing (S16). In other words, not only the cores 210 and 220, but also the cores 230 and 240, which are the general-purpose processing cores, are assigned to the image processing; accordingly, the image processing is performed by the cores 210 to 240 (also refer to FIG. 7B), and thereby the delay in the processing time is recovered.

Note that the timing to increase the number of cores can be the timing of starting the image processing of image of one band.

Then, the CPU 200 determines whether or not the image processing of the document image that should be subjected to the image processing is completed (S17), and when the image processing is not completed (No in S17), the procedures return to step 12 to continue the processing.

When the image processing is completed (Yes in S17), if the number of cores to be assigned to the image processing is increased (Yes in S18), the number is restored (S19), to thereby finish the processing. Moreover, if the number of cores is not increased (No in S18), the processing is finished.

Note that, as the timing to restore the increased number of cores to an original state, timing of finishing the image processing of the image of one band can be considered, or timing during the image processing of the image of one band can also be considered. In other words, it can be considered that the cores 230 and 240 complete the image processing at the timing of completing the image processing of the image of one band, the image processing being performed by the cores 230 and 240 together with the cores 210 and 220, or at the other timing.

Next, processing procedures different from those in the case of the above-described FIGS. 8A to 8D will be described.

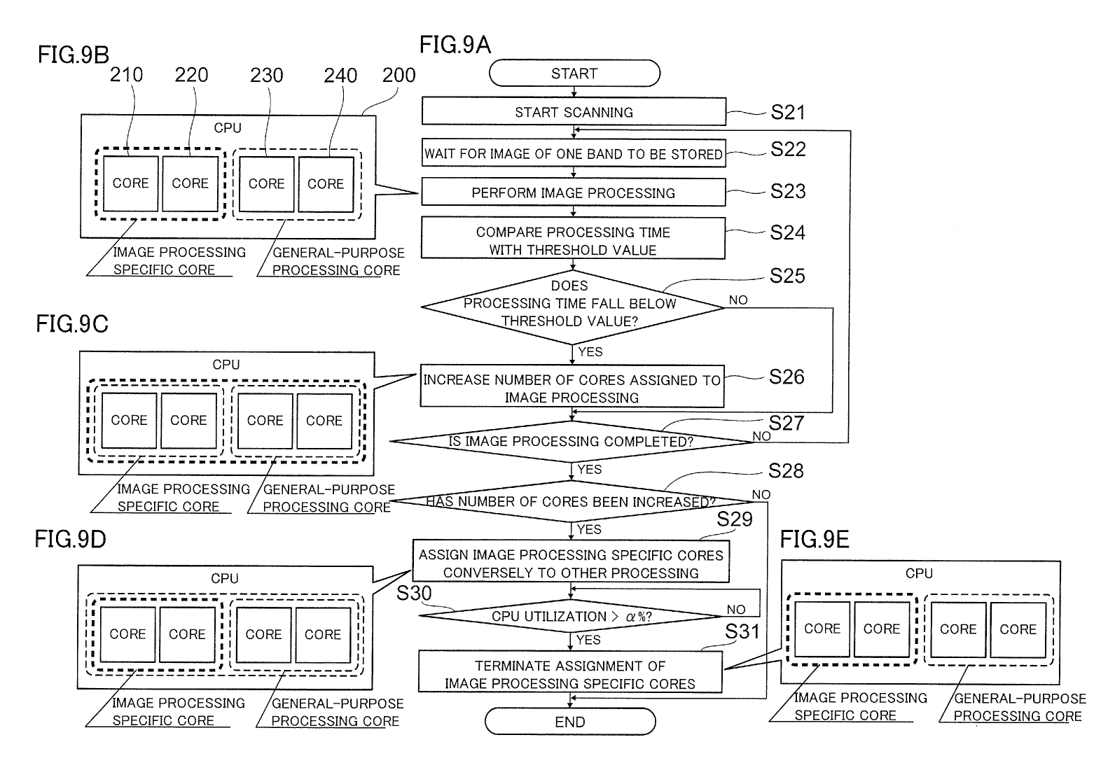

FIG. 9A is a flowchart illustrating other processing procedures of the core number control in the CPU 200, and FIGS. 9B to 9E are block diagrams illustrating how to specify tasks to cores in the CPU 200. Note that, since the processing contents in FIGS. 9A to 9E include common contents with the case of the above-described FIGS. 8A to 8D, descriptions in FIGS. 9A to 9E will be omitted in some cases. Specifically, S21 to S28 in FIG. 9A correspond to S11 to S18 in FIG. 8A. Note that distinction in the broken lines enclosing the cores 210 to 240 in FIGS. 9A to 9E between the bold line and the thin line is the same as the case in FIGS. 8A to 8D.

In the different processing procedures shown in FIGS. 9A to 9E, when the number of cores to be assigned to the image processing is increased (Yes in S28), the cores 210 and 220, which are the image processing specific cores, are conversely assigned to processing other than the image processing (S29). Consequently, since the other processing normally dealt with by the cores 230 and 240, which has been temporarily suspended to give priority to the image processing, is dealt with by the four cores, the delay in processing can be quickly recovered.

Then, the CPU 200 obtains or calculates information of the CPU utilization, and determines whether or not the CPU utilization is less than a % (S30). When the CPU utilization is less than a % (Yes in S30), since the CPU utilization with respect to the processing other than the image processing is reduced, assignment of the cores 210 and 220 to the other processing is canceled (S31). Moreover, when the CPU utilization is not less than a % (No in S30), monitoring of the CPU utilization is continued.

Note that, as the timing to cancel such assignment, the time when the next image processing is started can also be considered.

Note that, in the exemplary embodiment, a control is adopted, in which the processing time is compared with the threshold value, and when the processing time falls below the threshold value, the number of cores to be assigned to the image processing is increased; however, the control is not limited thereto, and it can be considered that the number of times of falling below such a threshold value is counted, and when the number reaches a predetermined value, for example, three, the number of cores is increased.

Moreover, an example can also be considered, in which the determination target is an average processing speed, not the processing time. For example, it is possible to consider a control in which an average processing speed in image processing is calculated, and when the average processing speed falls below a threshold value, the number of cores is increased, or, when the number of times of the average processing speed falling below the threshold value reaches three times, for example, the number of cores is increased. When the control using such a frequency limitation is adopted, examples can be considered to include the number of consecutive times or the number of cumulative times.

The foregoing description of the present exemplary embodiment of the present invention has been provided for the purposes of illustration and description. It is not intended to be exhaustive or to limit the invention to the precise forms disclosed. Obviously, many modifications and variations will be apparent to practitioners skilled in the art. The present exemplary embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

1. An image forming apparatus comprising:
a processor configured to act as:
a first information processing unit that performs information processing for image formation on obtained image data by an image processing specific program; and
a second information processing unit that performs processing other than image processing by a general-purpose processing program,
wherein, in a case where it is determined that an incomplete image would be generated when the first information processing unit alone performs information processing for image formation, the second information processing unit performs information processing for image formation in addition to the first information processing unit.

2. The image forming apparatus according to claim 1, wherein the second information processing unit performs the information processing for image formation on the image data by the general-purpose processing program when a processing time of the information processing for image formation by the first information processing unit falls below a predetermined threshold value.

3. The image forming apparatus according to claim 2, wherein the threshold value is set based on a reading speed of an image reading unit that reads a document, a processing speed of an output unit that outputs an image onto a recording material, processing performance of the first information processing unit and the second information processing unit, and a type of information processing for image formation.

4. An image forming apparatus comprising:
a processor configured to act as:
a first information processing unit that performs information processing for image formation on obtained image data by a program; and
a second information processing unit that performs information processing by a program, and, when a value related to the information processing by the first information processing unit satisfies a predetermined condition, performs information processing for image formation on the image data,
wherein, in a case where it is determined that an incomplete image would be generated when the first information processing unit alone performs information processing for image formation, the second information processing unit performs information processing for image formation together with the first information processing unit.

5. The image forming apparatus according to claim 4, wherein, when the information processing for image formation is performed on sequentially obtained image data, the second information processing unit starts the information processing for image formation at an obtaining timing of obtaining image data and terminates the information processing for image formation at a timing other than the obtaining timing.

6. The image forming apparatus according to claim 4, wherein, when the information processing for image formation is terminated, the first information processing unit performs information processing other than the information processing for image formation performed by the second information processing unit.

7. An information processing method comprising:
performing information processing for image formation on obtained image data by an image processing specific program;
determining whether an incomplete image would be generated when the first information processing unit alone performs information processing for image formation, and, if determined that the an incomplete image would be generated when the first information processing unit alone performs information processing for image formation, performing information processing for image formation on the image data by a general-purpose processing program also performing processing other than image processing in addition to the performing information processing for image formation on obtained image data by the image processing specific program.
